(19) United States
(12) Patent Application Publication
(10) Pub. No.: US 2019/0010855 A1
(43) Pub. Date: Jan. 10, 2019

(54) IMPROVED SLIP JOINT APPARATUS AND METHOD OF USE THEREOF

(71) Applicant: Teconnex Ltd, Keighley Yorkshire (GB)

(72) Inventor: Richard Green, Keighley Yorkshire (GB)

(73) Assignee: Teconnex Ltd, Keighley Yorkshire (GB)

(21) Appl. No.: 16/064,685

(22) PCT Filed: Dec. 14, 2016
(86) PCT No.: PCT/GB2016/053927

§ 371 Date: Jun. 21, 2018

(30) Foreign Application Priority Data
Dec. 22, 2015 (GB) 1522586.5

(51) Int. Cl. F01N 13/18; F16L 23/10

(52) U.S. Cl. CPC F01N 13/1811; F16L 27/12; F16L 23/10

(57) ABSTRACT

Slip joint apparatus is provided. The slip joint apparatus (100) includes a first component (4) having a first end (18) and a second component (6) having a second end. The second end of the second component arranged such that it can be brought into overlapping engagement with the first end of the first component in use. An intermediate joining element (108) is provided for helping to join the first and second components together in use. Movement limitation means (20) are provided on or associated with, at or adjacent the first end (18) of the first component (4) for limiting movement of at least part of the intermediate joining element (108) in at least one direction relative to said first component (4) in use.

This invention relates to improved slip joint apparatus and to a method of using the same.

A slip joint is generally used to join two components together, and which either allows continuous relative movement of the two components or to allow adjustment of the components from one temporarily fixed position to another temporarily fixed position in use.

Although the following description refers almost exclusively to slip joint apparatus for use in joining two equal or similar diameter pipes together, such as for example the assembly of pipes forming a vehicle exhaust system to allow the flow of exhaust gases along the joined pipes, it will be appreciated by persons skilled in the art that the slip joint apparatus of the present invention could be used in any suitable application for allowing relative movement or adjustment of any two components in use.

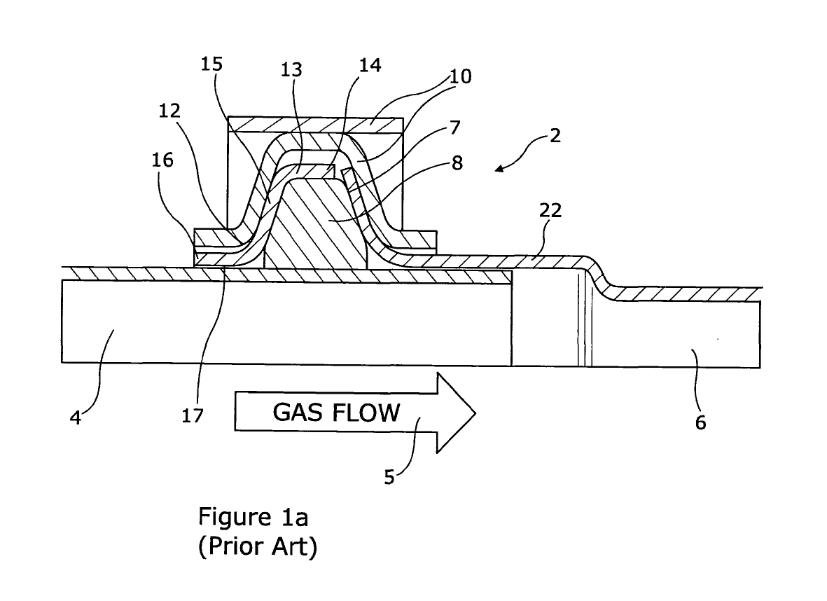

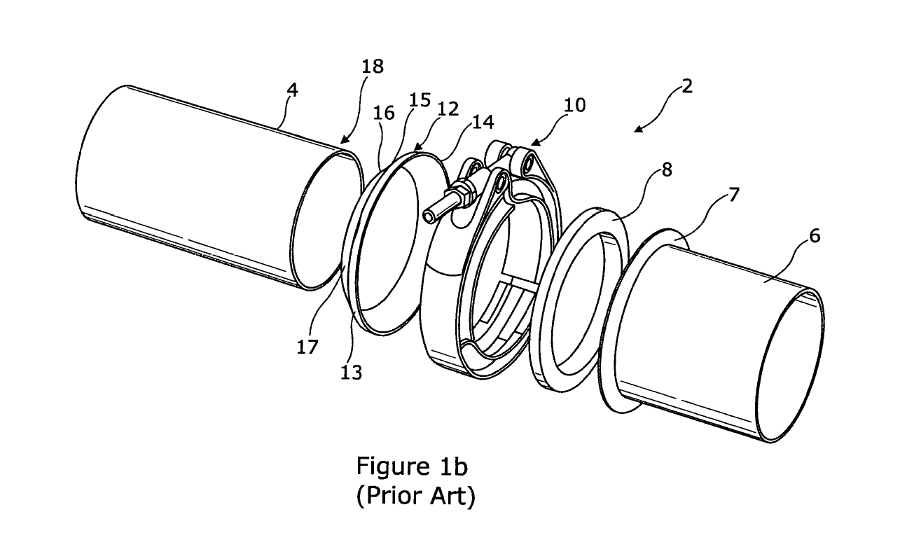

With reference to FIGS. 1a and 1b, there is illustrated an example of a conventional slip joint assembly 2 used for the connection of two cylindrical pipes together; inlet pipe 4 and outlet pipe 6, in a vehicle exhaust system. With the pipes 4, 6 joined together, exhaust fluid flows along the joined pipe, as shown by arrow 5. Outlet pipe 6 has a flared free end 7. A slip flare 12 is provided for location over the free end of the inlet pipe 4. Slip flare 12 has a first skirt or flat platform section 13 adjacent end 14 which is outwardly flared or of larger diameter to a second skirt or flat platform section 17 adjacent second end 16. A single step or joining element 15 is located between the first and second skirt sections 13, 17 of slip flare 12. When assembled, the slip flare 12 is located over the free end. 18 of inlet pipe 4, together with a sealing gasket 8. The free end 18 of inlet pipe 4 is inserted into the flared open end of outlet pipe 6, such that gasket 8 is in abutting relationship with the slip flare 12 and the flared free end 7 of the outlet pipes 6. A retaining clamp 10 is provided over the flared free end 7, the gasket 8 and slip flare 12 to retain the slip joint together in use. Use of the slip joint in this application allows a degree of tolerance between the two pipes, meaning that the length of the inlet and outlet pipes is not critical. This is of particular benefit when the pipework is being manufactured as the forming, cutting and/or assembly of individual pipes can result in deviations in the lengths of the pipes. If a standard joint is used rather than a slip joint; a standard joint being where pipe ends butt up to a flare, the deviation in pipe length would result in the pipe ends being either too far apart or too close together. This would place stress on the joint and could result in failure of the joint in use.

Pipe joints can form either a closed box system or an open box system. A closed box system is where the inlet and outlet pipes are fixed to rigid mountings to prevent movement of the pipes in a linear direction (i.e. in a direction parallel to the longitudinal axis of the pipes). A conventional flared pipe joint typically works well for this type of system. An open box system is where the inlet and outlet pipes are not fixed. A potential problem with an open box system is that the two joined pipes can separate in use, resulting in failure of the joint. The problem of pipe separation and joint failure can arise under certain operating conditions, such as for example during prolonged high internal pressure and/or high vibration; as a result of a higher than normal internal pressure or burst of pressure; as a result of an incorrectly assembled or manufactured joint; as a result of two slip joints being arranged in a parallel arrangement, such as either side of a U-section assembly, such that the two joints are able to work together to walk/creep apart with prolonged usage under normal operating conditions, and/or the like.

It is therefore an aim of the present invention to provide improved slip joint apparatus that overcomes the abovementioned problems.

It is a further aim of the present invention to provide a method of using improved slip joint apparatus.

According to a first aspect of the present invention there is provided slip joint apparatus, said slip joint apparatus including a first component having a first end and a second component having a second end, the second end of the second component arranged such that it can be brought into overlapping engagement with the first end of the first component in use, and an intermediate joining element for helping to join the first and second components together in use, and wherein movement limitation means are provided on or associated with, at or adjacent the first end of the first component for limiting movement of at least part of the intermediate joining element in at least one direction relative to said first component in use.

Thus, the slip joint apparatus of the present invention provides at least partial containment of at least part of the intermediate joining element in use, to limit the movement of the intermediate joining element in at least one direction relative to the first component. This helps to prevent separation of the first and second components when joined together in use.

Preferably the first and/or second components have a longitudinal axis or axes and limitation of movement in the at least first direction is in a direction parallel or substantially parallel to the longitudinal axis or axes of the first and/or second components.

Preferably the first and/or second components are elongate or substantially elongate in form.

Preferably the first and/or second components are hollow or substantially hollow.

In one embodiment the first and/or second components are any or any combination of one or more pipes, conduits, sleeve members, channel members and/or the like.

Preferably the first and/or second components are cylindrical or substantially cylindrical in shape.

Preferably the second end of the second component is brought into overlapping arrangement with the first end of the first component by inserting a free end of the first component into an open free end of the second component during assembly of the apparatus.

Preferably the first and/or second ends of the first and second components are free ends.

Preferably the second end of the second component is flared or has a flared end, and preferably an outwardly flared end. Thus, preferably the dimensions or diameter of the free second end of the second component are larger or significantly larger than the dimensions or diameter of the second component set back from the free second end.

Preferably at least one skirt or platform section is provided between the flared second end and the remaining section of the second component, or the section of the second component that is set back from the second end.

Preferably the dimensions and/or diameter of the at least one skirt or platform section are larger than the remaining section of the second component but smaller than the dimensions and/or diameter of the flared second end.

Preferably the at least one skirt or platform section of the second component is flat, planar, substantially flat or substantially planar, such as for example in cross section. Further preferably the at least one skirt or platform section of the second component is flat, planar, substantially flat or substantially planar in a direction parallel to the longitudinal axis of the second component.

Preferably a step is formed or provided between the at least one skirt or platform section and the remaining section of the second component. The step typically acts as a limit to which the first end of the first component can be inserted through the second component in use. The first end of the first component typically abuts with the internal step of the second component to limit movement of the same in a forwardly or insertion direction into the second component.

Preferably the height or depth of the step of the second component is at least the thickness of the material from which the first component is formed.

Preferably the step of the second component is inwardly protruding into a hollow interior of the second component.

Preferably the step of the second component is perpendicular, substantially perpendicular, or at an acute angle to the longitudinal axis of the second component.

In one embodiment the intermediate joining element is in the form of a slip flare.

In one embodiment the intermediate joining element is in the form of an annular or substantially annular member.

In one embodiment at least part of the intermediate joining element is of complementary or substantially complementary shape to at least part of the first component onto which or around which it is located in use.

Preferably the intermediate joining element has a first end and a second end. Preferably the first end is flared or has larger dimensions and/or diameter compared to the second end.

Preferably a first skirt or platform is provided at or adjacent the first end of the intermediate joining element. Preferably a second skirt or platform is provided at or adjacent the second end of the intermediate joining element.

In one embodiment the first end of the first component is located through the second end of the intermediate joining element during assembly of the slip joint apparatus. Alternatively, a second end of the first component is located through a first end of the intermediate joining element during assembly.

In one embodiment an intermediate section is provided between the first skirt/platform/end and the second skirt/platform/end. Preferably the intermediate section has larger dimensions and/or diameter compared to the second skirt/platform/end, and smaller dimensions and/or diameter compared to the first end, skirt or platform.

Preferably a first step is provided between the first end, skirt or platform and the intermediate section, and at least a second step is provided between the intermediate section and the second end, skirt or platform.

Preferably the first skirt or platform, the second skirt or platform and/or the intermediate section are flat, planar, substantially flat or substantially planar in cross section, and further preferably are flat, planar, substantially flat or substantially planar in cross section or in a direction parallel to the longitudinal axis of the first component.

Preferably the second skirt, platform or step of the intermediate joining element is arranged to be engageable with or locatable in the movement limitation means provided on the first component in use.

Preferably the first and/or second steps of the intermediate joining element are perpendicular, substantially perpendicular, or at an acute angle to the longitudinal axis of the first component.

Preferably the height or depth of the second step is equal to, substantially equal to, greater than or slightly greater than the height or depth of the movement limitation means defined in or associated with the first component.

Preferably the height or depth of the second step is equal to, substantially equal to, greater or slightly greater than the thickness of the material used to form the intermediate joining element.

Preferably the height or depth of the first step is equal to, substantially equal to, greater than or slightly greater than the height or depth of sealing means that may be located at least partially under or relative to the first step in use.

The term “slightly greater” is preferably defined as dimensions just big enough to allow clearance between one component that is arranged to overlap with another component in use.

Preferably the width of the second skirt or platform of the intermediate joining element is such so as to be located in the movement limitation means and movable therein or relative thereto in use and/or provides sufficient stiffness to the skirt or platform so as to prevent or substantially prevent lifting of the same over part or out of the movement limitation means in use.

Preferably the width of the first skirt or platform of the intermediate joining section is such so as to be wholly or at least partially overlapping with at least a top surface of the sealing means in use.

Preferably the width of the intermediate section of the intermediate joining section is such so as to allow the first skirt or platform of the intermediate joining section to be engaged with a wall of the movement limitation means nearest to the first end of the first component, while maintaining the sealing means in contact with a surface of the first component and/or preventing the first end of the intermediate joining section from extending beyond the first end of the first component.

In one embodiment the intermediate joining element or slip flare has a split or gap provided between the first and second ends of the same. This split or gap allows the diameter or dimensions of the intermediate joining element or slip flare to increase/expand and/or decrease/contract to allow fitting of the intermediate joining element or slip flare onto the first component in use.

Preferably the split or gap defined in the intermediate joining element or slip flare is arranged parallel or substantially parallel to the longitudinal axis or axes of the first and/or second components and/or the intermediate joining section.

In one embodiment the ends of the intermediate joining element or slip flare defining the split or gap are parallel or substantially parallel.

In an alternative embodiment the ends of the intermediate joining element or slip flare defining the split or gap are non-parallel and/or overlapping.

Preferably the width of the gap or split between the free ends of the intermediate joining element or slip flare is dependent on the dimensions or diameter of the end of the first component over which it is located in use and/or the dimensions or diameter of the movement limitation means defined on the first component.

Preferably the intermediate joining element or slip flare is in the form of a single integrally formed member.

Preferably the intermediate joining element or slip flare is pressed out of flat plate material, such as stainless steel or other metal(s). However, the intermediate joining element or slip flare could also be formed from tube or cylindrical material if required which is then cut or formed to a required size.

In one embodiment the movement limitation means are in the form of a recess or inwardly flared section defined in the first component a spaced distance apart or set back from the first free end of the first component.

In one embodiment the movement limitation means are in the form of a protrusion or outwardly flared section defined in the first component a spaced distance apart or set back from the first free end of the first component, or at the first free end of the first component.

Preferably the recess or protrusion of the movement limitation means has at least a first step or side wall located a spaced distance from the first end of the first component. This first step or side wall defines the most forward position the intermediate joining section can travel along the first component in the direction towards the first end of the first component in use.

Preferably the height of the first step or side wall of the movement limitation means is equal to, substantially equal to or smaller than the height or depth of the second step on the intermediate joining element.

Preferably the recess of the movement limitation means has a second step or side wall located a spaced distance apart from the first step or side wall. Further preferably the second step or side wall is spaced apart from the first step or side wall in a direction parallel to the longitudinal axis of the first component. The second step or side wall defines the most rearward position the intermediate joining element can travel away from the first end of the first component in use.

Preferably the width of the recess between the first step or side wall and the second step or side wall is such so as to allow the second skirt of the intermediate joining element to be slidably movable therein in use, and further preferably is slidably movable in a direction parallel to the longitudinal axis of the first component in use.

Preferably the width between the first end of the first component and the first step or side wall of the movement limitation means is such so as to maintain sealing means in contact with this width between the most forwardly and rearwardly positions of the intermediate joining element in use and/or to maintain overlap between the first and second components when joined together in use.

In one embodiment the slip joint assembly includes sealing means for providing a seal between at least the first and second components when joined together in use.

Preferably the sealing means are located between the flared open end of the second component, at least the first skirt or end of the intermediate joining element and the outer surface of the first component in use.

Preferably the sealing means includes one or more gaskets, rubber members, o-rings and/or the like.

The sealing means can include one or more flat or profiled surfaces.

Preferably the sealing means is annular or substantially annular in shape.

In one embodiment the slip joint assembly includes clamping means for clamping the slip joint together in use. Preferably the clamping means clamps the first and second components, the intermediate joining element and/or the sealing means together in use.

Preferably the clamping means are movable between a first clamped position, wherein the components being clamped are prevented or substantially prevented from moving under normal conditions, and a second unclamped position, wherein the components being clamped can be assembled or disassembled and/or moved relative to the clamping means.

It is to be noted that in certain operating conditions, one or more components of the slip joint apparatus are movable to a limited degree (as defined by the movement limitation means) even when in the clamped position, such as for example the intermediate joining element relative to the movement limitation means in use.

Preferably the clamping means includes movement means or mechanism for moving the clamping means between the clamped and unclamped positions. Preferably the movement means or mechanism includes one or more threaded screws, nuts and bolts, trunnions and/or the like. Rotation of the threaded screws or nuts and bolts can move free ends of the clamping means towards each other to form the clamped position and away from each other to form the unclamped position.

Preferably the clamping means include any of a band clamp, v-clamp, ring clamp and/or the like.

Preferably the clamping means includes a band having two opposing free ends, or the clamping means has two opposing free ends.

Further preferably the two opposing free ends are movable towards each other to form the clamped position and away from each other to form the unclamped position.

Preferably there is a gap formed between the two opposing free ends, at least in the unclamped position. In one embodiment there is a gap formed between the two opposing free ends in the clamped position as well. Preferably this gap is at least partially or wholly aligned or overlapping with the split or gap of the intermediate joining element when the apparatus is assembled in use. This allows the clamping means to compress or apply a compression force to the intermediate joining element in use, and particularly to or adjacent the split or gap of the intermediate joining element.

Preferably the shape of the clamping means or at least an inner surface of the clamping means which is to engage with one or more of the components in use is complementary or substantially complementary in shape to the outer surface of the component. For example, the clamping means or inner surface of the clamping means can be annular, circular or substantially annular or circular in shape.

In one embodiment the clamping means can include a single clamping member or can include two or more clamping members, such as for example an outer clamping member and an inner clamping member, or two or more clamping members formed in an end to end arrangement to form at least an annular or substantially annular shape in a clamped position.

The clamping means or one or more clamping members can be profiled or non-profiled, segmented or non-segmented and/or the like.

In one embodiment the clamping means, first component, second component and/or intermediate joining section is/are formed from one or more metals, such as stainless steel.

In one embodiment the slip joint apparatus can be used for joining two components, pipes or conduits of a vehicle exhaust system together.

In one embodiment the slip joint apparatus can be used in a fixed arrangement wherein there is negligible or no movement between the first and second components in use.

In one embodiment the slip joint apparatus can be used in a dynamic arrangement wherein there is movement, and preferably sliding movement between the first and second components in use. The dynamic arrangement can be advantageous in applications where one or more components of the apparatus may be subjected to changes in temperature which result in expansion and/or contraction of said components. For example, the flow of hot exhaust gases through first and second pipes joined together with the slip joint apparatus of the present invention can result in one or more of the components undergoing expansion and/or contraction in use and the movement within the joint caused by this expansion and/or contraction can be accommodated as a result of movement of the intermediate joining section within the constraints of the movement limitation means.

According to a second aspect of the present invention there is provided a method of using and/or assembling slip joint apparatus.

According to one aspect of the present invention there is provided a method of using slip joint apparatus, said slip joint apparatus including a first component having a first end and a second component having a second end, and an intermediate joining element, said method including the steps of bringing the second end of the second component into overlapping engagement with the first end of the first component in use, applying the intermediate joining element to the first and/or second components to help to join the first and second components together in use, and wherein movement limitation means are provided on or associated with, at or adjacent the first end of the first component for limiting movement of at least part of the intermediate joining element in at least one direction relative to said first component in use.

According to a further aspect of the present invention there is provided slip joint apparatus, said slip joint apparatus including a first pipe or conduit having a first end and a second pipe or conduit having a second end, the second end of the second pipe or conduit arranged such that it can be brought into overlapping engagement with the first end of the first pipe or conduit in use, and a slip flare element for helping to join the first and second pipes or conduits together in use, and wherein movement limitation means are provided on or associated with, at or adjacent the first end of the first pipe or conduit for limiting movement of at least part of the slip flare element in at least one direction relative to said first conduit or pipe.

Thus, the present invention provides a slip joint with a containment feature to limit the amount of linear slip of the joint in use.

Embodiments of the present invention will now be described with reference to the following figures, wherein:

FIGS. 1a and 1b (PRIOR ART) show a partial cross sectional view and a perspective view of a conventional slip joint respectively;

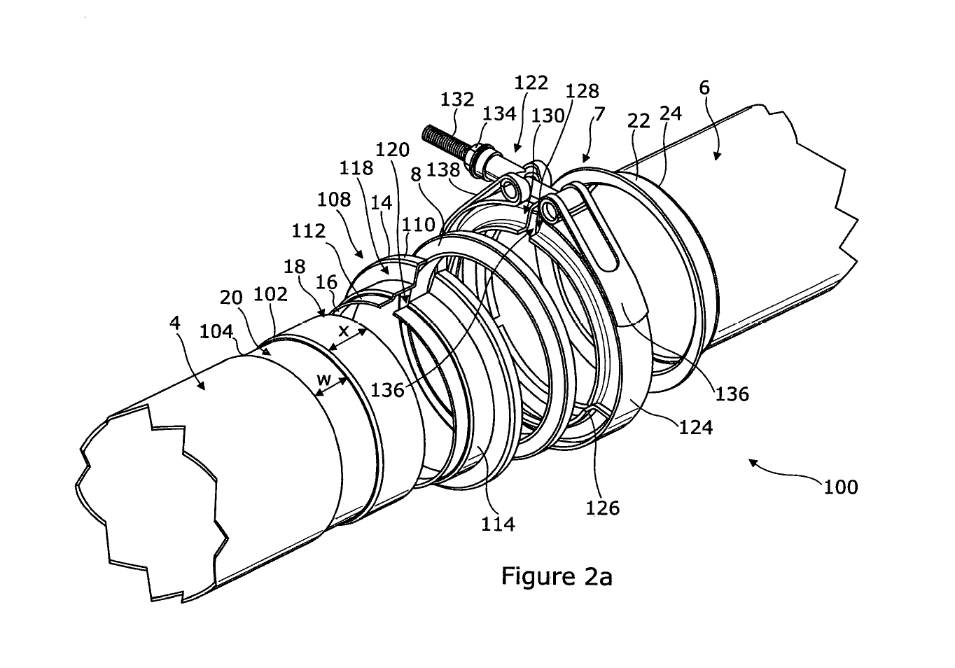

FIGS. 2a and 2b show a perspective view and a partial cross sectional view of slip joint apparatus according to an embodiment of the present invention respectively;

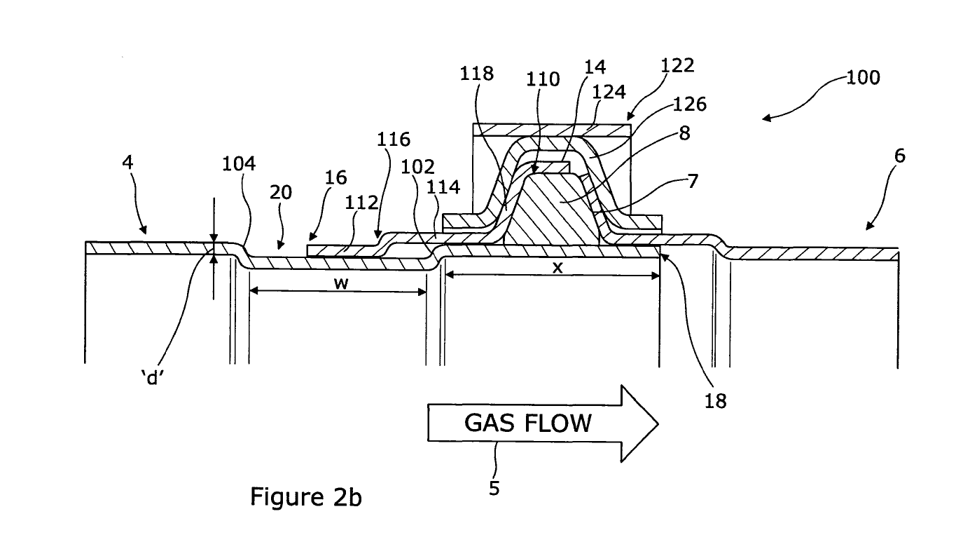

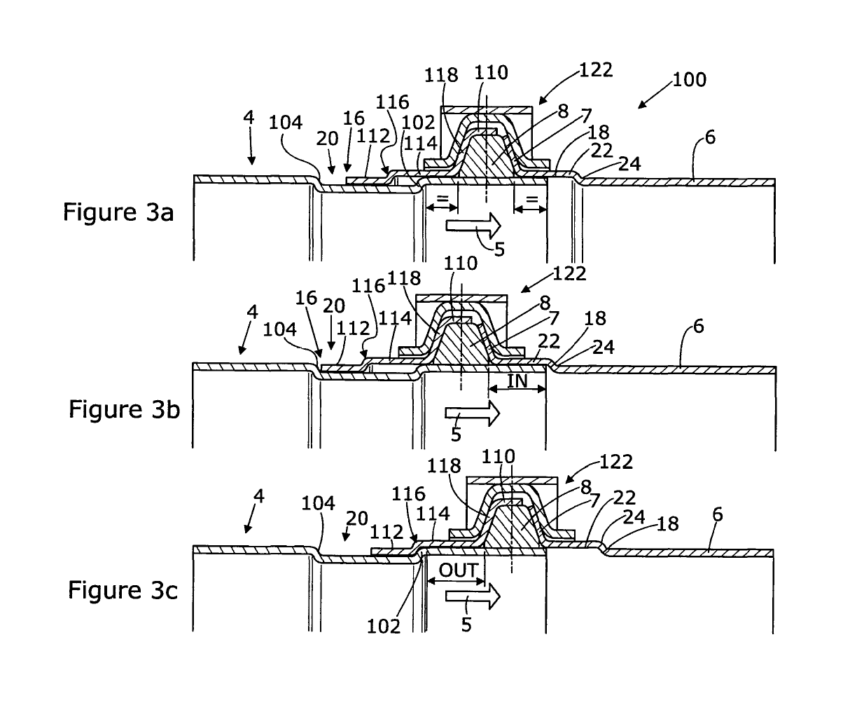

FIGS. 3a-3c show partial cross sectional views of the slip joint in FIGS. 2a and 2b in a central position, forwards position and backwards position respectively;

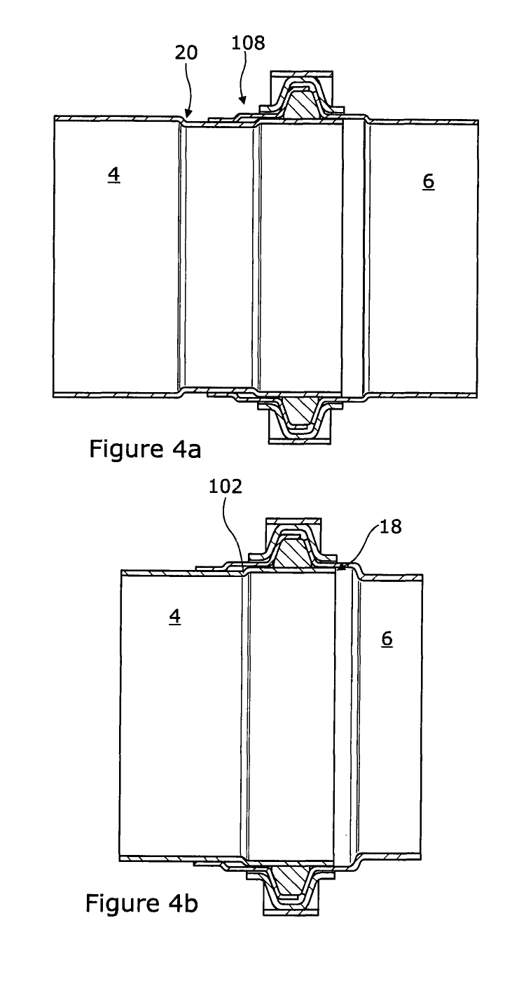

FIG. 4a shows a cross sectional view of a slip joint assembly according to one embodiment of the present invention, and FIG. 4b shows a cross sectional view of a slip joint assembly according to a further embodiment of the present invention.

Referring firstly to FIGS. 2a-4a, there is illustrated a slip joint assembly 100 according to a first embodiment of the present invention for use in a vehicle exhaust system. The same reference numerals are used to describe the same features as shown in FIGS. 1a-1b.

The slip joint assembly 100 includes a cylindrical inlet pipe 4 and a cylindrical outlet pipe 6. Both pipes 4, 6 are hollow and are arranged to allow the flow of fluid, such as vehicle exhaust gases, along the same when joined in use.

Inlet pipe 4 has a first free end 18. Movement limitation means in the form of a recess 20 is defined around pipe 4 a pre-determined distance ‘x’ set back from first end 18. The distance ‘x’ is such so as to be sufficient to allow sealing means in the form of a gasket 8 to be located on the same in use, and to provide sufficient overlap between the inlet pipe 4 when located in the outlet pipe 6 in use.

Recess 20 as a width ‘w’ defined between a front side wall 102 (recess side wall closest to the first free end 18) and a rear side wall 104 (recess side wall furthest from the first free end 18). Recess 20 also has a depth ‘d’ defined between a base surface 106 of the recess 20 and a top edge of the side walls 102, 104.

Outlet pipe 6 has an outwardly flared free end 7. A joining section 22 is defined between outlet pipe 6 and flared free end 7. Joining section 22 has a larger diameter or dimensions compared to the diameter or dimensions of outlet pipe 6 but a smaller diameter or dimensions compared to the diameter or dimensions of the flared free end 7. A first step 24 is defined between the outlet pipe 6 and the joining section 22.

An intermediate joining element or slip flare 108 is provided for engagement with the first pipe 4 in use. The slip flare 108 is annular in shape and has a first skirt section 110 defining a first end 14 and a second skirt section 112 defining a second end 16. First end 14 and first skirt section 110 have a larger diameter than second skirt section 112 and second end 16. In accordance with the present invention an intermediate section 114 is defined between the first and second skirt sections 110, 112. Intermediate section 114 has a larger diameter than second skirt section 112 and a smaller diameter than first skirt section 110.

A second step or wall 116 is defined between the second skirt section 112 and the intermediate section 114. A first step or wall 118 is defined between the intermediate section 114 and the first skirt section 110.

The first skirt section 110, the second skirt section 112 and the intermediate section 114 are flat or planar in cross section.

The second skirt section 112 is typically of such width so as to allow the same to undergo limited sliding movement within recess 20 in a forwards and/or rearwardly linear manner in a direction parallel to the longitudinal axis of the pipes 4, 6.

The second step or wall 116 is the same or similar dimensions to the depth ‘d’ of side walls 102, 104 of recess 20 on first pipe 4. The second step or wall 116 prevents the second skirt section 112 from lifting out of recess 20 in use.

The first step or wall 118 is the same or similar dimensions to the height or depth of gasket 8.

A split or gap 120 is defined through the slip flare 108 between the first end 14 and second end 16 to allow for expansion and contraction of the slip flare 108. In particular, the gap 120 allows the diameter of the slip flare 108 to increase or decrease depending on whether the slip flare is placed under relative tension or compression respectively during the fitting process. This allows the slip flare 108 to be located over the larger diameter free end 18 of inlet pipe 4 and for the second skirt section 112 to sit in the smaller diameter recess 20 when assembled.

In order to assemble the slip joint 100, slip flare 108 is engaged with inlet pipe 4 by moving second end 16 of slip flare 108 over the first end 18 of inlet pipe 4 until second skirt section 112 locates in recess 20 on inlet pipe 4. Sealing gasket 8 is located over first end 18 of inlet pipe 4 onto width ‘x’ section so as to abut with the underside surface of the first step 118 and to sit under the first skirt section 110 of the slip flare 108. The flared end 7 of outlet pipe 6 is moved into engagement with the gasket 8 such that at least part of the width ‘x’ of inlet pipe 4 is located inside outlet pipe 6 in overlapping engagement, as shown in FIG. 2b, and the flared end abuts side wall of gasket 8. A retaining clamp 122 is then located around the inlet pipe 4, the outlet pipe 6, the slip flare 108 and the gasket 8 to retain the components together in a clamped manner.

The retaining clamp 122 in this example is in the form of a band clamp including an outer annular clamping member 124 and an inner segmented annular clamping member 126. The outer and inner clamping members 124, 126 have two opposing free ends 128, 130. Movement means in the form of a threaded bolt 132 and nut 134 are provided between the two free ends 128 130 (via joining straps 136) to allow the free ends to be moved together to form a clamped position and moved apart to form an unclamped position in use. A gap 138 is defined between the two free ends 128, 130.

The gap 138 of the retaining clamp 122 is typically at least partially or wholly aligned or overlapping with the split 120 of the slip flare 108, thereby allowing the slip flare to be compressed under the clamping force of the retaining clamp in use.

With the slip joint 100 assembled, the second skirt section 112 is able to move within recess 20 but the side walls 102, 104 of the recess 20 limit movement of the second skirt section as a result of second step 116 abutting against either side wall 102, 104. Thus, the slip flare 108 is capable of undergoing forwardly and/or rearwardly sliding movement in a linear direction, typically parallel to the longitudinal axis of the pipes 4, 6, in a restricted or contained manner. This feature ensures that in the event of any of the conditions that may have conventionally resulted in failure of the joint as set out above, the inlet and outlet pipes 4, 6 can only separate by a pre-determined amount equal to the degree of movement of second skirt 112 within width ‘w’ of the recess 20, and the joint remains intact.

FIG. 3a shows the slip joint 100 in a nominal central position, wherein inlet and outlet pipes 4, 6 have freedom of movement in a forwardly direction (i.e. in the direction of the media flow through the pipe or towards second pipe) and/or a rearwardly direction (i.e. in the direction against the media flow through the pipe or towards the first pipe). In this position, the second skirt section 112 is located centrally of the recess 20, there is a relatively small space between the second step 116 and the front side wall 102, gasket 8 is located centrally of the width ‘x’ adjacent the first free end 18 of pipe 4, and first free end 18 of inlet pipe 4 is a spaced distance apart from first step 24 on outlet pipe 6.

FIG. 3b shows the slip joint 100 in a forwardly position (i.e. when the inlet and outlet pipes 4, 6 are as close together as they can be when assembled). In this position, the second end 16 of the second skirt section 112 abuts against rear side wall 104 of recess 20, there is a relatively large space between the second step 116 and the front side wall 102, gasket 8 is located adjacent or close to front side wall 102 and a relatively large distance from free end 18 of inlet pipe 4, and free end 18 of inlet pipe abuts against first step 24 of outlet pipe 6. Thus, there is greater overlap between the inlet and outlet pipes 4, 6 in this position, and step 24 on outlet pipe 6 prevents further forwardly movement of inlet pipe 4 relative to outlet pipe 6, together with rear side wall 104 of recess 20.

FIG. 3c shows the slip joint 100 in a rearwardly position (i.e. when the inlet and outlet pipes 4, 6 are as far apart as they can be when assembled). In this position, the second step 116 of the second skirt section 112 abuts against front side wall 102 of recess 20, gasket 8 is located adjacent or close to free end 18 of inlet pipe 4 and a relatively large distance from side wall 102 of recess 20, and free end 18 of inlet pipe 4 is a spaced distance apart from first step 24 of outlet pipe 6. Thus, there is the least overlap between the inlet and outlet pipes 4, 6 in this position, and side wall 102 of recess 20 prevents further rearwardly movement (i.e. separation of the pipes 4, 6).

The slip flare 18 is able to slidably move between the three different positions shown above in use but further movement beyond the forwardly and rearwardly limits is prevented.

Although the above embodiment describes the movement limitation means on the inlet pipe as being in the form of a recess or internally flared as shown in FIGS. 2a-4a, it will be appreciated that the movement limitation means on the inlet pipe could be in the form of a protrusion or be externally flared instead, as shown in FIG. 4b. This latter arrangement results in improved fluid flow within the pipe since there is nothing protruding into the hollow pipe interior as there is with the recess embodiment shown in FIGS. 2a-4a. In the externally flared arrangement, the section of the pipe adjacent first end 18 has greater dimensions or diameter compared to the dimensions or diameter of the pipe behind step 102. The width of the flared section is equivalent to the width ‘x’ as with the first embodiment. There is no rear wall 104 to help limit forwards movement of the pipes 4, 6 as there is with the first embodiment but the step 22 on the second pipe 6 still acts to limit forwards movement of the pipes 4, 6. In this embodiment, it is also possible that the gap 120 in the slip flare is not required if the slip flare can be loaded onto the inlet pipe from an end other than the first end 18.

1. Slip joint apparatus, said slip joint apparatus including a first component having a first end and a second component having a second end, the second end of the second component arranged such that it can be brought into overlapping engagement with the first end of the first component in use, and an intermediate joining element for helping to join the first and second components together in use, and wherein movement limitation means are provided on or associated with, at or adjacent the first end of the first component for limiting movement of at least part of the intermediate joining element in at least one direction relative to said first component in use.

2. Slip joint apparatus according to claim 1 wherein the first and/or second components have one or more of the following features: are elongate or substantially elongate in form, are hollow or substantially hollow, are cylindrical or substantially cylindrical in shape, are any or any combination of one or more pipes, conduits, sleeve members or channel members.

3. Slip joint apparatus according to claim 1 wherein the first and/or second components have a longitudinal axis or axes and limitation of movement in the at least first direction is in a direction parallel or substantially parallel to the longitudinal axis or axes of the first and/or second components.

4. Slip joint apparatus according to claim 1 wherein the second end of the second component is flared and/or is outwardly flared.

5. Slip joint apparatus according to claim 4 wherein at least one skirt or platform section is provided between the flared second end and a remaining section of the second component.

6. Slip joint apparatus according to claim 5 wherein dimensions and/or a diameter of the at least one skirt or platform section is larger than the dimensions and/or diameter of the remaining section of the second component but smaller than the dimensions and/or diameter of the flared second end.

7. Slip joint apparatus according to claim 5 wherein the at least one skirt or platform section is flat, planar or substantially flat or planar.

8. Slip joint apparatus according to claim 5 wherein a step is provided between the at least skirt or platform section and the remaining section of the second component to act as a limit to which the first end of the first component can be inserted through an open end of the second component in use.

9. Slip joint apparatus according to claim 8 wherein the step protrudes inwardly of a hollow interior of the second component and/or a height or depth of the step is at least the thickness of the material from which the first component is formed.

10. Slip joint apparatus according to claim 1 wherein the intermediate joining element is any or any combination of in the form of a slip flare, an annular member, a substantially annular member, or is complementary or substantially complementary in shape to at least part of the first component onto which or around which it is located in use.

11. Slip joint apparatus according to claim 1 wherein the intermediate joining element has a first end and a second end, the first end is flared or has larger dimensions or diameter compared to the second end.

12. Slip joint apparatus according to claim 1 wherein the intermediate joining element has a first skirt or platform provided at or adjacent a first end, and a second skirt or platform provided at or adjacent a second end, and an intermediate section provided between the first end, skirt or platform and the second end, skirt or platform, the intermediate section having larger dimensions and/or diameter compared to the second end, skirt or platform, and smaller dimensions and/or diameter compared to the first end, skirt or platform.

13. Slip joint apparatus according to claim 12 wherein the second end, skirt or platform of the intermediate joining element is engageable with or locatable in the movement limitation means provided on the first component in use.

14. Slip joint apparatus according to claim 12 wherein a first step is provided between the first end, skirt or platform and the intermediate section, and at least a second step is provided between the intermediate section and the second end, skirt or platform.

15. Slip joint apparatus according to claim 14 wherein a height or depth of the second step is equal to, substantially equal to, greater than or slightly greater than a height or depth of the movement limitation means defined in or associated with the first component and/or the thickness of the material used to form the intermediate joining element.

16. Slip joint apparatus according to claim 14 wherein a height or depth of the first step is equal to, substantially equal to, greater than or slightly greater than a height of depth of sealing means that are locatable at least partially under or relative to the first step in use.

17. Slip joint apparatus according to claim 12 wherein a width of the second skirt or platform of the intermediate joining element is such so as to be locatable in the movement limitation means and movable therein or relative thereto in use and/or is of sufficient stiffness to prevent, or substantially prevent, lifting of the same over part or out of the movement limitation means in use.

18. Slip joint apparatus according to claim 12 wherein a width of the first skirt or platform of the intermediate joining element is such so as to be wholly or at least partially overlapping with at least a top surface of sealing means in use.

19. Slip joint apparatus according to claim 1 wherein the intermediate joining element has a split or gap provided between first and second ends of the same.

20. Slip joint apparatus according to claim 1 wherein the movement limitation means are in the form of a recess, an inwardly flared section defined in the first component a spaced distance or set back from a first free end of the component, or in the form of a protrusion or outwardly flared section defined in the first component a spaced distance apart or set back from the first free end of the first component, or at the first free end of the component.

21. Slip joint apparatus according to claim 20 wherein a height of a first step or side wall of the recess, inwardly flared section, protrusion or outwardly flared section is equal to, substantially equal to or smaller than a height of a second step of the intermediate joining element.

22. Slip joint apparatus according to claim 20 wherein the recess has a first step or side wall and a second step or side wall and the width of the recess between the same is such so as to allow a second skirt of the intermediate joining element to be slidably movable therein in use.

23. Slip joint apparatus according to claim 1 wherein sealing means are provided to form a seal between at least the first and second components when joined together.

24. Slip joint apparatus according to claim 23 wherein the sealing means are locatable between a flared open end of the second component, at least a first skirt or end of the intermediate joining element and an outer surface of the first component in use; includes one or more gaskets, rubber members or O-rings; include one or more flat or profiled surfaces and/or is annular or substantially annular in shape.

25. Slip joint apparatus according to claim 1 wherein clamping means are provided for clamping the first component, second component, the intermediate joining element and/or sealing means together in use.

26. Slip joint apparatus according to claim 25 wherein the clamping means are movable between a first clamped position, wherein the component being clamped are prevented or substantially prevented from moving under normal conditions, and a second unclamped position, wherein the components being clamped can be assembled and/or disassembled and/or moved relative to the clamping means.

27. Slip joint apparatus according to claim 26 wherein the clamping means include movement means for moving the clamping means between the clamped and unclamped positions, the movement means including one or more threaded screws, nuts and bolts and/or trunnions.

28. Slip joint apparatus according to claim 26 wherein the clamping means is in the form of a band clamp, a V-clamp or a ring clamp.

29. Slip joint apparatus according to claim 26 wherein the clamping means has two opposing free ends and a gap is provided between the two opposing free ends at least in the unclamped position, said gap is arranged to be at least partially or wholly aligned or overlapping with a split or gap provided in the intermediate joining element when the apparatus is assembled in use.

30. Slip joint apparatus according to claim 1 wherein it is used for joining two components, pipes or conduits of a vehicle exhaust system together.

31. Slip joint apparatus according to claim 1 wherein said apparatus is used in a fixed arrangement wherein there is negligible or no movement between the first and second components in use; or wherein said apparatus is used in a dynamic arrangement wherein there is movement between the first and second components in use.

32. A method of using slip joint apparatus, said slip joint apparatus including a first component having a first end and a second component having a second end, and an intermediate joining element, said method including the steps of bringing the second end of the second component into overlapping engagement with the first end of the first component in use, applying the intermediate joining element to the first and/or second components to help to join the first and second components together in use, and wherein movement limitation means are provided on or associated with, at or adjacent the first end of the first component for limiting movement of at least part of the intermediate joining element in at least one direction relative to said first component in use.
